(19) United States
(12) Patent Application Publication
(10) Pub. No.: US 2021/0317951 A1
(43) Pub. Date: Oct. 14, 2021

(54) DEVICE FOR FILLING PRESSURIZED GAS TANKS

(71) Applicant: L'Air Liquide, Societe Anonyme pour l'Etude et l'Exploitation des Procedes Georges Claude, Paris (FR)

(72) Inventors: Etienne WERLEN, Sassenage (FR); Clemence DEVILLIERS, Sassenage (FR)

(73) Assignee: L'Air Liquide, Societe Anonyme pour l'Etude et l'Exploitation des Procedes Georges Claude, Paris (FR)

(21) Appl. No.: 17/227,151

(22) Filed: Apr. 9, 2021

(30) Foreign Application Priority Data
Apr. 10, 2020 (FR) FR 2003618

(51) Int. Cl. F17C 5/00

(52) U.S. Cl. CPC F17C 5/007; F17C 2205/0367; F17C 2270/0168; F17C 2221/012; F17C 2205/0326

(57) ABSTRACT

Device for filling pressurized gas tanks, particularly hydrogen tanks of vehicles, comprising a fluid transfer circuit comprising an upstream end having a plurality of pressurized fluid sources and a downstream end comprising at least two dispensers, each designed to be connected to different tanks to be filled, each source comprising a fluid outlet connected to an outlet valve, at least some of the outlet valves being connected in parallel to each of the at least two dispensers via at least two parallel transfer pipes.

### CROSS-REFERENCE TO RELATED APPLICATIONS

This application claims the benefit of priority under 35 U.S.C. § 119 (a) and (b) to French patent application No. FR 2003618, filed Apr. 10, 2020, the entire contents of which are incorporated herein by reference.

### BACKGROUND

### Field of the Invention

The invention relates to a device for filling pressurized gas tanks, particularly hydrogen tanks of vehicles.

More particularly, the invention relates to a device for filling pressurized gas tanks, particularly hydrogen tanks of vehicles, comprising a fluid transfer circuit comprising an upstream end having a plurality of pressurized fluid sources and a downstream end comprising at least two dispensers, each designed to be connected to different tanks to be filled, each source comprising a fluid outlet connected to an outlet valve.

### Related Art

In some filling stations, the hydrogen is delivered in high-pressure gas containers (usually trailers carrying tubular tanks) divided into a plurality of independent storage banks. These tanks are fitted with outlet valves so that a specific storage bank can be selected to supply the station. The resupply is usually carried out with a strategy of successive operations to balance the pressure between the storage banks and the vehicle tank (cascade operation). This is used, in particular, in stations that have no compressors.

To optimize the logistics, the amount of hydrogen in the source storage bank must be reduced to a minimum before they are replaced with full source storage banks.

For this purpose, conventionally, the balancing is carried out initially with source storage banks at relatively low pressure, and then with the source storage banks at increasing pressure.

Some resupply stations must be fitted with a plurality of dispensers. This is the case, for example, in stations for filling the tanks of heavy goods vehicles, or in those that have to supply several tanks simultaneously.

The stations are usually connected to transportable source storage banks via a connector. In this configuration, it is impossible to supply two tanks to be filled at different pressures simultaneously (see EP1942300A1).

Thus the logistics cannot be entirely optimized for the simultaneous resupply of two tanks, since the single manifold has to be connected to a source storage bank under sufficient pressure to supply the dispenser that is most demanding in terms of pressure (or flow rate).

The document US20030164202A1 describes a station with a compression unit and a plurality of dispensers, a source and a plurality of fixed buffer storage banks.

The known solutions do not allow a plurality of vehicles to be filled simultaneously and optimally with cascade transfers from different sources, notably transportable sources. The logistics of source use and supply cannot be optimized.

### SUMMARY OF THE INVENTION

One aim of the present invention is to overcome all or some of the aforementioned disadvantages of the prior art.

To this end, the device according to the invention, which in other respects matches the generic definition given in the above preamble, is essentially characterized in that at least some of the outlet valves are connected in parallel to each of the at least two dispensers via at least two parallel transfer pipes.

Furthermore, embodiments of the invention can comprise one or more of the following features:
at least some of the outlet valves are connected in parallel to the same first manifold pipe of the circuit, and the dispensers are also connected in parallel to said first manifold pipe via a plurality of transfer pipes,
the first manifold pipe of the circuit comprises a set of isolating valve(s), each interposed between two adjacent transfer pipes,
a respective upstream control valve is placed in the circuit between each outlet valve and the at least two parallel transfer pipes,
a respective downstream control valve is placed in each of the transfer pipes connecting the dispensers to the sources,
the adjacent transfer pipes have no fluid connection between them, or have a fluid connection comprising a restriction member configured to restrict said fluid connection by reducing the cross section for the passage of the fluid from one transfer pipe to another to less than 10%, preferably less than 0.1%, of the passage cross section of the fluid in a transfer pipe,
the sources, the upstream control valves, and at least some of the transfer pipes are housed on or in a source support forming a physical entity removably connected to the rest of the circuit of the filling device,
each of the transfer pipes comprises removable fluid connection members forming separable fluid connection members between the part of the circuit housed in or on the support and the other part of the circuit connected to the dispensers,
the circuit comprises a plurality of transfer pipes, the dispensers being connected in parallel to a plurality, and preferably to all, of the transfer pipes via a set of downstream pipes having downstream valves,
the circuit comprises downstream pipes, respectively comprising the dispensers, said downstream pipes each comprising at least one fluid member chosen from among a calibrated aperture, an actuating valve, a flow meter, a controlled valve, a discharge valve, and a hose portion,
at least some of the valves are controlled valves.

The invention may also relate to any alternative device or process comprising any combination of the features above or below within the scope of the claims.

### BRIEF DESCRIPTION OF THE FIGURES

Further particular features and advantages will become apparent from reading the following description, given with reference to the figures, in which:

FIG. 1 shows a schematic partial view of the general structure of an example of a device according to the invention,

FIG. 2 shows a schematic partial view of the structure and operation of a first example of embodiment of a device according to the invention,

FIG. 3 shows a schematic partial view of the structure and operation of a second example of embodiment of a device according to the invention,

FIG. 4 shows a schematic partial view of the structure and operation of a third example of embodiment of a device according to the invention.

### DETAILED DESCRIPTION OF THE INVENTION

The device 1 for filling pressurized gas tanks, particularly hydrogen tanks of vehicles, comprises a fluid transfer circuit comprising an upstream end having a plurality of pressurized fluid sources 2 to 10 (on the left in the illustrations) and a downstream end (on the right in the illustrations) comprising at least two dispensers 11, 12, 13, each designed to be connected to different tanks to be filled (simultaneously or not, the tanks possibly being different according to the filling profiles).

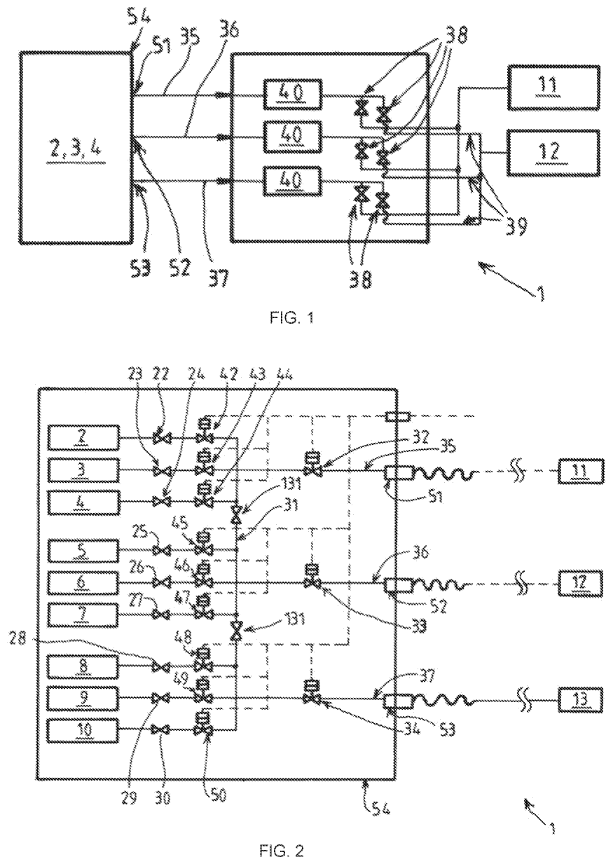

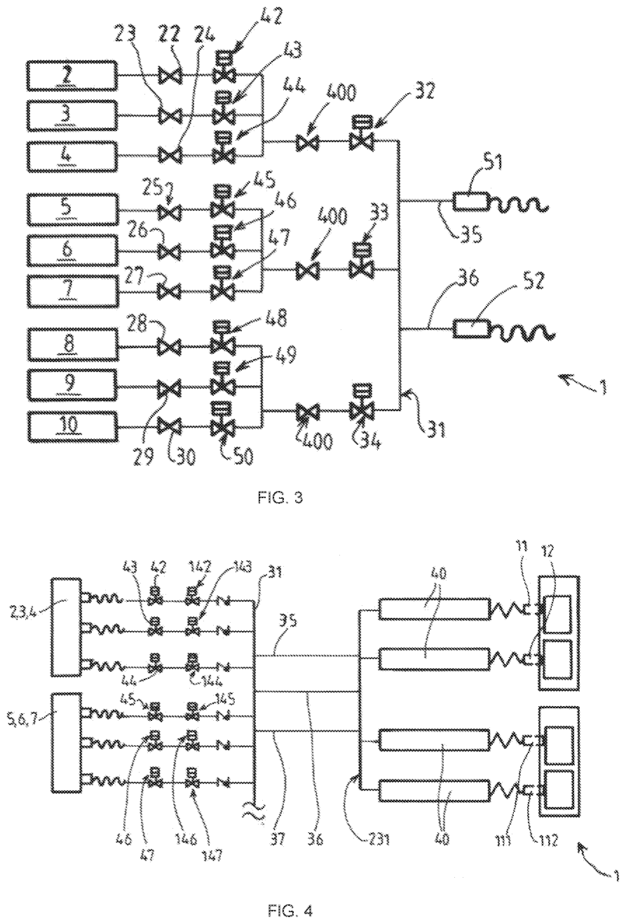

As shown in FIG. 2 and FIG. 3, each source 2 to 10 comprises a fluid outlet connected to a respective outlet valve 22 to 30. It should be noted that, for the sake of simplicity, the apertures of each source and its associated valve are denoted below by the adjective “outlet”. Evidently, this outlet aperture and this associated outlet valve may be used, if necessary, for the admission of fluid when the source has to be refilled (notably if the source has no separate filling aperture).

At least some of these outlet valves 22 to 30 (and preferably all of them) are connected in parallel to each of the at least two dispensers 11 to 13.

In the examples of FIG. 1 and FIG. 3, the device 1 comprises two dispensers 11, 12 at the downstream end. In the example of FIG. 2, the device 1 comprises three dispensers 11, 12, 13 at the downstream end. In the example of FIG. 4, the device 1 comprises four dispensers 11, 12, 111, 112 at the downstream end. Any other number of dispensers greater than two would be feasible.

The number of pressurized fluid sources 2 to 10 at the upstream end may be three (FIG. 1), nine (FIG. 2 or FIG. 3), six (FIG. 4) or any appropriate number (four, five, six, eight or more than nine).

The dispensers 11, 12 are connected in parallel to the transfer pipes 35, 36, 37 via a set of downstream pipes 39 each having downstream valves 38.

This enables any dispenser to be supplied with gas from any source, and, notably, enables two dispensers to be supplied simultaneously with sources having different pressures or flow rates.

As shown in FIG. 2 and FIG. 4, the outlet valves 22 to 30 may be connected in parallel to the same first manifold pipe 31 of the circuit. Downstream, the dispensers 11, 12, 13 may also be connected in parallel to this same first manifold pipe 31 via respective parallel transfer pipes 35 to 37.

The adjacent transfer pipes 35, 36, 37 preferably have no fluid connection between them, or have a fluid connection comprising a restriction member configured to restrict said fluid connection by reducing the passage cross section of the fluid from one transfer pipe to another to less than 10%, preferably less than 0.1%, of the passage cross section of the fluid in a transfer pipe 35, 36, 37. For example, the restriction member comprises an isolation valve and/or a calibrated aperture.

Similarly, a respective upstream control valve 42 to 50 may be placed in the circuit between each outlet valve 22 to 30 and the first manifold pipe 31.

A respective downstream control valve 32, 33, 34 is preferably placed in each transfer pipe 35 to 37 connecting the dispensers 11, 12, 13 to the manifold pipe 31. However, these downstream control valves 32, 33, 34, which provide double isolation of the sources, may be omitted.

As shown in FIG. 2, the first manifold pipe 31 of the circuit preferably comprises a set of isolating valve(s) 131, each interposed between two adjacent transfer pipes 35, 36, 37. These isolating valves 131 may be used, in the closed position, to isolate one or more transfer pipes from the adjacent transfer pipes (and therefore to isolate dispensers). In the closed position, these isolation valves 131 also prevent the transfer of fluid from a set of sources to one or more transfer pipes 35, 36, 37 (and therefore to one or more dispensers).

However, the presence of the first manifold pipe 31 and the isolating valves 131 is optional. That is to say, these valves 131 and the interconnections between the groups of sources may be omitted.

As shown schematically in FIG. 2, the sources 2 to 10, the upstream control valves 22 to 30, the downstream valves 32, 33, 34 and at least some of the transfer pipes 35 to 37 may be housed on or in a source support 54 or casing forming a physical entity removably connected to the rest (downstream) of the circuit of the filling device 1. Typically, the support 54 is integrated into a removable container or into a semi-trailer designed to be replaced periodically in a “full for empty” exchange mode.

That is to say, the whole of this upstream part of the device 1 may be movable and may be replaced when the sources are emptied below a certain threshold, while the downstream part of the device 1 may remain fixed at the filling site.

For this purpose, the transfer pipes 35 to 37 may each comprise removable fluid connection members (quick-release connectors or others) 51, 52, 53, forming separable fluid connection members between the upstream part of the circuit housed in or on the support 54 and the other, downstream, part of the circuit connected to the dispensers 11 to 13.

The embodiment of FIG. 3 differs from that of FIG. 2 in that the sources 2 to 10 are connected further downstream to a first manifold pipe 31. More precisely, the sources 2 to 10, their respective outlet valves 22 to 30 and their upstream control valves 42 to 50 are connected in groups (of three in this example) to respective portions of pipe having a downstream control valve 32, 33, 34. The downstream control valves 32 to 34 (three in this example) are connected downstream to a first common manifold pipe 31. Additionally, a valve 400 (of an isolating or other type) may if necessary be associated upstream of each downstream control valve 32 to 34 in the portion of pipe connected to a set of sources. Evidently, this valve 400 may be omitted.

Downstream, two transfer pipes 35, 36 are connected in parallel to the first common manifold pipe 31. These two transfer pipes 35, 36 may comprise, downstream, removable fluid connection members 51, 52 and/or a hose portion, designed to be connected to the dispensers downstream.

The embodiment of FIG. 4 differs from that of FIG. 2 in that two sets of sources 2, 34 and 5, 6, 7 are connected in parallel via a plurality of lines (six in this example) to a first common manifold pipe 31. Each line may comprise, in series, at least one of: a quick-release connector, a hose portion, a first upstream control valve 42 to 47, a check valve, and a second upstream control valve 142 to 147. In particular, the second upstream control valve 142 to 147 may be omitted. Vent valves may also be provided upstream of the first control valves 42 to 47, for purging the hoses after the connection of new sources, for example.

Downstream, a plurality of transfer pipes 35 to 37 (three in this example) are connected in parallel to the first common manifold pipe 31. Downstream, these three transfer pipes 35 to 37 are connected to a second common manifold pipe 231.

The dispensers 11, 12, 111, 112 (four in this example) are connected in parallel to this second common manifold pipe 231.

The downstream pipes, comprising the dispensers 11, 12, 111, 112, may comprise at least one fluid member 40 chosen from among a calibrated aperture, an actuating valve, a flow meter, a controlled valve, a discharge valve, and a hose portion. Typically, the dispenser or the downstream pipe carrying the dispenser comprises at least one of: an automatic isolating valve, a set of manual valves of the “double block and bleed” type (isolation for maintenance), a filter, a flow meter, a flow control valve (or a controlled pressure relief valve or a calibrated aperture), a pressure transmitter, a safety valve, a cooling exchanger, an automatic isolating valve, a safety valve, one or two pressure transmitters, an automatic vent valve, one or two temperature sensors, a hose break-away system, a hose and a pistol or nozzle.

Thus the device 1 may advantageously comprise a plurality of connecting lines (usually hoses) between the transportable gas sources and the fixed downstream part.

A plurality of dispensers may be connected to these connecting lines.

Some or all of the valves may be controlled, notably in an automatic way.

The control of the valves may enable each dispenser to be supplied from different sources.

In the configuration of FIG. 1 and FIG. 2, notably, this makes it possible, for example, to supply a dispenser (first tank to be filled) with a source at low pressure, while simultaneously resupplying another dispenser with another source at a higher pressure in order to complete the resupply of a second tank to be filled.

In this way, the use of the (transportable) source containers may be optimized, because the lower pressure available in the sources may be transferred to the vehicles in an optimal way.

Each source may comprise a plurality of independent storage banks fitted with respective valves (usually of the on-off type) for selecting the storage bank connected to a connecting line.

Preferably, an electronic controller (computer, microprocessor or other) may control the valves for the purpose of, notably, selecting the most appropriate source for supplying the dispenser concerned.

Evidently, the above embodiments are not limiting, notably as regards the number of sources, pipes, dispensers, valves, etc.

The fluid flow rate may be distributed among a plurality of pipes/lines if a plurality of sources are connected in parallel for refuelling very high-volume tanks (those on trains, for example). This makes it possible to limit or reduce the number of components that must be adapted to very high flow rates.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A device for filling pressurized gas tanks, comprising a fluid transfer circuit that comprises an upstream end having a plurality of pressurized fluid sources and a downstream end comprising at least two dispensers, each of the upstream end and downstream end being designed to be connected to different pressurized gas tanks to be filled, each source comprising a fluid outlet connected to an outlet valve, wherein:
at least some of the outlet valves are connected in parallel to each of the at least two dispensers via at least two parallel transfer pipes;
at least some of the outlet valves are connected in parallel to a same first manifold pipe of the circuit; and
the at least two dispensers are also connected in parallel to said first manifold pipe via a plurality of transfer pipes.

2. The device of claim 1, wherein the first manifold pipe of the circuit comprises a set of isolating valve(s), each being interposed between two adjacent ones of said at least two parallel transfer pipes.

3. The device of claim 1, wherein, between each outlet valve and the at least two parallel transfer pipes, a respective upstream control valve is placed in the circuit.

4. The device of claim 1, wherein in each transfer pipe, a respective downstream control valve is placed connecting the dispensers to the plurality of sources.

5. The device of claim 1, wherein the adjacent transfer pipes have no fluid connection between them, or have a fluid connection comprising a restriction member configured to restrict said fluid connection by reducing the passage cross section of the fluid from one transfer pipe to another to less than 10% of the passage cross section of the fluid in a transfer pipe.

6. The device of claim 3, wherein the plurality of sources, the upstream control valves, and at least some of the transfer pipes are housed on, or in, a source support that forms a physical entity that is removably connected to a rest of the circuit of the filling device.

7. The device of claim 6, wherein the transfer pipes each comprise removable fluid connection members, forming separable fluid connection members between the part of the circuit housed in, or on, the support and another part of the circuit connected to the dispensers.

8. The device of claim 1, wherein the dispensers are connected in parallel to at least a plurality of the at least two parallel transfer pipes via a set of downstream pipes having downstream valves.

9. The device of claim 8, wherein at least some of the set of downstream pipes respectively comprise the dispensers, said downstream pipes each comprising at least one fluid member, the at least one fluid member being a calibrated aperture, an actuating valve, a flow meter, a controlled valve, a discharge valve, or a hose portion.

10. The device of claim 1, wherein at least some of the valves are controlled valves.

11. The device of claim 1, wherein the device for filling pressurized gas tanks is adapted and configured to fill hydrogen tanks of vehicles.
